(19) United States
(12) Patent Application Publication
(10) Pub. No.: US 2025/0036892 A1
(43) Pub. Date: Jan. 30, 2025

(54) AN INTEGRATED READER SYSTEM

(71) Applicant: Avery Dennison Retail Information Services LLC, Mentor, OH (US)

(72) Inventor: Mark W. ROTH, North Miami, FL (US)

(21) Appl. No.: 18/711,638

(22) PCT Filed: Dec. 16, 2022
(86) PCT No.: PCT/US2022/081829

§ 371 Date: May 20, 2024

Related U.S. Application Data
(60) Provisional application No. 63/291,157, filed on Dec. 17, 2021.

(51) Int. Cl. G06K 7/10; G06Q 10/0833

(52) U.S. Cl. CPC G06K 7/10207; G06K 7/10217; G06K 7/10415; G06Q 10/0833

(57) ABSTRACT

The present subject matter disclosed herein relates to an integrated reader system. The integrated reader system comprises a reader that continuously/non-continuously monitors an area within a transport unit of a vehicle including doors of the transport unit. The reader is operatively connected to an energy storage device configured to independently power the RFID reader. The reader system also comprises a processor configured to cause the RFID reader to move from a first state to a second state based on detection of different events by one or more sensors of the integrated reader system.

### BACKGROUND

Tracking and tracing of shipments are becoming increasingly important worldwide. Logistics and supply chain management firms are increasingly required to possess track and trace capabilities to monitor the movement of each parcel moving from across town to around the globe. Radio frequency identification devices (RFID) or RFID tags are increasingly used to track a large number of different articles. RFID tags are specially seeing widespread use in shipping containers to enable logistics firms to track individual containers as they move through various locations to the customer.

Typically, RFID tags on storage containers or transport units in trucks are tracked and located by portable or stationary reader/interrogator systems such as hand-held readers or dock door portals respectively. However, both hand-held readers and dock door portals have certain disadvantages. For example, a hand-held reader may have a limited means of controlling the RF signal field size in high inventory areas. The dock door portals are not mobile solutions and cannot be easily redeployed. Moreover, in locations such as airports, where the facilities are not owned by the logistics carriers, installing fixed infrastructure is not possible. Moreover, hand held readers require the involvement of a person who must carry the reader and perform the scan, during which time the person cannot help with any loading or unloading activities.

It is also known that RFID readers can be powered by means of AC wall adapter circuits or POE connections whereby power is delivered via a communication cable. RFID readers consume power in an idle state as well as when tasked to perform an inventory read cycle. The reader's antenna ports can be individually selected and turned on or all turned on simultaneously. Each option has an impact on how much power is required to support the load of a read event. Additionally, when reader's ports are selected the firmware in the reader directs the transceiver to rotate through each antenna at a predetermined rate. This works exceptionally well in achieving the highest possible read rate performance, however, this may involve high power consumption. For example, turning on a single antenna may require 1.5 amps but turning on all four antennas in a reader may require more power thus increasing the power consumption.

Higher power consumption is a real concern especially in mobile battery powered world. Batteries no matter what technology or chemistry do not provide longevity when abused such as under deep discharge conditions. Regardless of the type of battery used, there is a need for understanding the battery power requirements based on reader demands. Moreover, compliance of reader designs with regulatory limits such as only one antenna port can be on at any given time must also be considered.

Accordingly, improvements over conventional systems are needed for portable RFID reader systems.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

In some embodiments, an integrated reader system may comprise an RFID reader, a processor operatively connected to the RFID reader, one or more sensors including a door sensor operatively connected to the RFID reader and an energy storage device operatively connected to the RFID reader. The energy storage device is configured to independently power the RFID reader. The RFID reader is configured to function in one of a first state and a second state based on detection of different events.

In some embodiments, the integrated reader system may be provided in a transport unit of vehicle for reading RFID tags of items stored in the transport unit.

In some embodiments, upon detection of movement of a door of the transport unit by a door sensor and upon communication of the same to the processor, the RFID reader is caused to change its mode of operation from a first state including a low power state to the second state including a high power state.

In some embodiments, upon detection of predetermined events by the processor, the RFID reader is caused to change its mode of operation from the first state including an idle state to a second state including an active state.

In some embodiments, upon detection of prohibited events, the processor is configured to trigger an alert.

In some embodiments, the integrated reader system comprises a charging circuit that is operatively connected to the energy storage device to charge and recharge the energy storage device.

In some embodiments, the charging circuit may be connected to a wiring harness of a vehicle carrying at least one transport unit.

In some embodiments, the integrated reader system comprises a camera. The camera is configured to capture real time images when the doors of the transport unit are opened and transmits the real time images to a processor. The processor may trigger an alert when a prohibited event is detected and communicated to the processor. In some embodiments, the trigger for a prohibited event may go off when movement of a door is detected. In some embodiments, the trigger for a prohibited event may go off when a door of the vehicle is left open for a predetermined amount of time.

In some embodiments, the integrated reader system comprises a cellular communication module. In some embodiments, the cellular communication module is configured to communicate real time location of the transport unit with the processor.

In some embodiments, the integrated reader system is secured in a mounting tray covered with a lid.

In some embodiments, the integrated reader system is secured to opposite walls of the transport unit, just below a ceiling of the transport unit.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF DRAWINGS

FIG. 1 illustrates a block diagram of an integrated reader system in accordance with some embodiments.

FIG. 2A illustrates a rear view of a vehicle comprising a transport unit in a closed state in accordance with some embodiments.

FIG. 2B illustrates a rear view of a vehicle comprising a transport unit in an open state in accordance with some embodiments.

FIG. 3A illustrates a perspective view of a mounting tray adapted to secure an integrated reader system in accordance with some embodiments.

FIG. 3B illustrates a perspective view of a mounting tray with a lid adapted to secure an integrated reader system in accordance with some embodiments.

FIG. 3C illustrates a perspective view of a mounting tray assembly adapted to be secured to a portion of a transport unit of a vehicle in accordance with some embodiments.

FIG. 3D illustrates a front perspective view of a telescoping tube as inserted in a fixed support structure in accordance with some embodiments.

FIG. 4 is a block diagram of an exemplary computer system in accordance with some embodiments.

FIG. 5 are illustrative diagrams of computer program products in accordance with some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. The terms “one or more of a, b, and c”, “at least one of a, b, and c”, and “at least one of a, b, or c” are intended to refer to a, b, c, or combinations thereof including 1) one or multiple of a and one or multiple of b, 2) one or multiple of b and one or multiple of c, 3) one or multiple of a and one or multiple of c, 4) one or multiple of a, 5) one or multiple of b, or 6) one or multiple of c.

In some embodiments, an integrated reader system is provided for reading radio frequency identification (RFID) tags. In some embodiments, the reader system comprises a reader that continuously/non-continuously monitors an area within a transport unit of a vehicle. In some embodiments, the transport unit is a trailer of the vehicle. In some embodiment, the transport unit may be permanently attached to the vehicle and in other embodiments the transport unit may be detachably attached to the transport unit. The transport unit may have doors, and the area or parts being monitored may include the doors of the transport unit. In some embodiments, the door may be a split swinging door. In other embodiments, the door may be a roll up door. In some embodiments, the transport unit may be accessed via the doors disposed at a rear of the vehicle. In other embodiments, the transport unit may be accessed via the doors disposed at one or both sides of the vehicle. In some other embodiments, the transport unit may be accessed through both the doors disposed at the rear of the vehicle and through the doors disposed at the sides of the vehicle.

According to an aspect of the present subject matter, the vehicle comprising the transport unit is adapted to hold one or more pallets or parcels; at least an RFID tag positioned on each of said pallets, or parcels. The vehicle is provided with an integrated reader system configured to read the RFID tags. In some embodiments, the pallets or parcels may be tagged with both a barcode and an RFID tag.

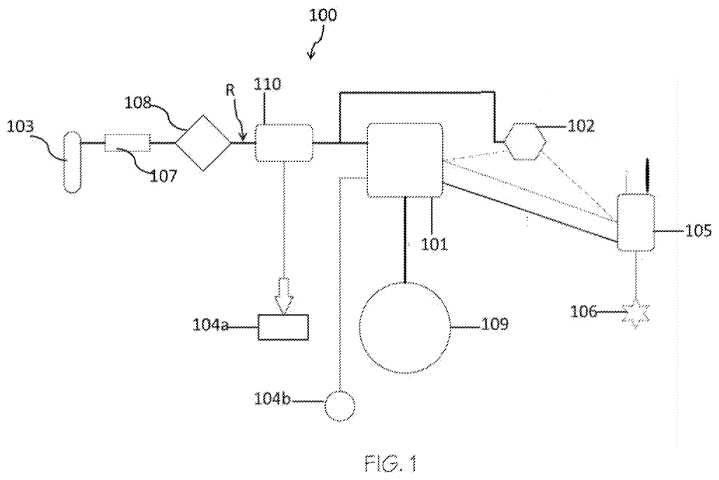

In some embodiments such as shown in FIG. 1, an integrated reader system 100 comprises one or more of any of a reader 101, a processor 102, an energy storage device 103, one or more sensors 104, a cellular communication module 105, and a camera 106. In some embodiments, the reader 101 is operatively connected to the energy storage device 103 via a relay circuit R comprising a fuse 107, a switch 108 and a relay unit 110. In some embodiments, the reader 101 is a micro reader. In various embodiments, the sensors 104 may be configured to measure one or more of any of the following parameters: temperature, resistance, capacitance, conduction, voltage, acceleration, infrared, light, or ultrasound. For example, the sensors may include one or more of any of the following: temperature sensors, proximity sensors, contact sensors, pressure sensors, smoke sensors, gas sensors, liquid sensors, position sensors, magnetic sensors, tilt sensors, flow sensors, level sensors, touch sensors, strain sensors, or weight sensors.

In some embodiments, the energy storage device 103 is an on-board battery pack built into a main housing of the transport unit. The battery pack may be recharged by one or more means to maintain the battery capacity level.

For example, in some embodiments, the energy storage device 103 is connected to a charging circuit (not shown). The charging circuit may comprise one of a solar cell or a motor generator. In some embodiments, the charging circuit may be functionally connected to a wiring harness of the vehicle. Connection to an independent rechargeable energy storage device 103 allows the reader 101 to read at any time, including during a partial delivery.

In some embodiments, the energy storage device 103 such as the on-board battery pack may be connected to a remote battery unit provided in the transport unit and may be charged by the remote battery unit. The battery capacity of the on-board battery pack is maintained by DC-DC charging from the remote battery unit. The remote battery unit is recharged when the transport unit is connected/attached to the vehicle. Presence of both the on-board battery pack and the remote battery unit are especially useful in vehicles where the transport unit is detachable from the rest of the vehicle. In other words, presence of the on-board battery pack and the remote battery unit allows the reader 101 of the integrated reader system 100 to be charged even when the transport unit is detached from the vehicle, thereby allowing the reader 101 to perform reading even the transport unit is detached from the vehicle.

In some embodiments, the energy storage device 103 such as the on-board battery pack may be connected to a power unit (not shown) in the vehicle, the power unit being used to supply power to electrical components of the vehicle including electrically powered/hydraulic doors or shutters of the vehicle. Thus, an existing power source can be used to charge the on-board battery pack and the on-board battery pack can in turn charge or otherwise power the reader 101.

According to an aspect of the present subject matter, the integrated reader system 100 is configured to control reading performed by the reader 101 based on different operating conditions in the vehicle. For example, in some embodiments, the reading performed by the reader 101 is controlled based on opening or closing of the doors of the vehicle. For example, the one or more readers 101 may be operatively connected to one or more sensors 104, such as a door sensor 104a.

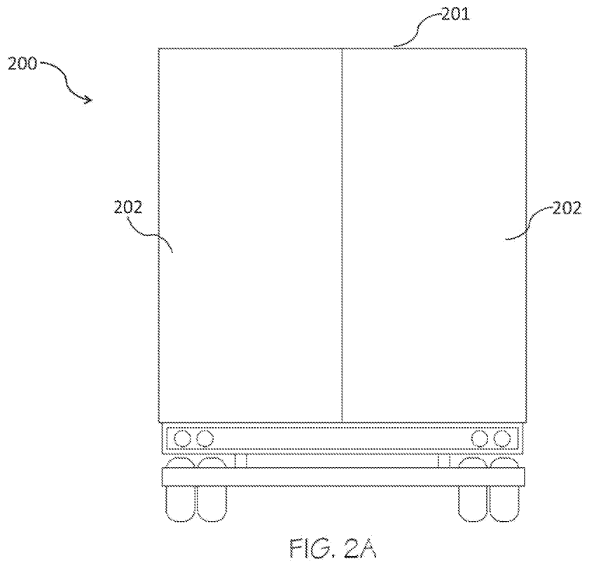

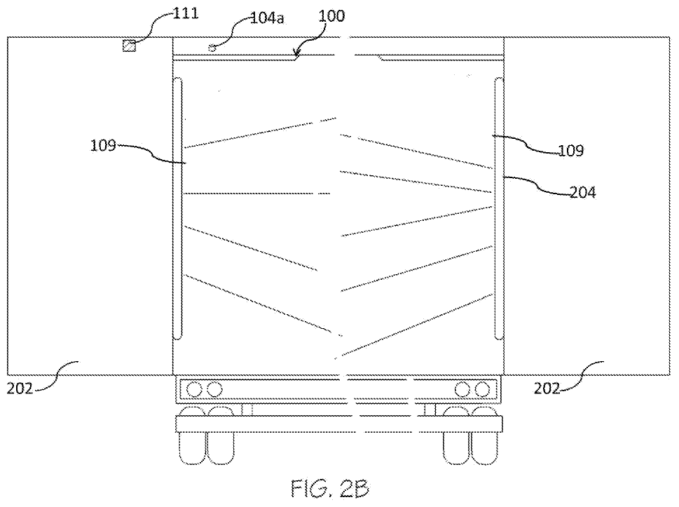

In some embodiments, the door sensor 104a is communicatively connected to the reader 101 via the relay unit 110. Thus, the door sensor 104a is configured to activate the reader 101 based on position and/or movement of the doors 202, such as whenever the doors 202 (shown in FIG. 2a) of a transport unit 201 of a vehicle 200 (shown in FIG. 2a) are opened or closed. For example, the door sensor 104a may enable the reader 101 to identify any nefarious or normal activity that may be attempted with the contents of the transport unit 201. The reader 101 being communicatively connected to the door sensor 104a also ensures that the reader 101 is switched ON and OFF when the doors 202 open and close respectively, thereby ensuring for some embodiments that there is optimal use of power from the energy storage device 103. In some embodiments, based on the detection of movement of doors 202, the reader 101 is caused to change its mode of operation. For example, based on door movement, the door sensor may trigger operation of the reader 101 to move from a low power state to a higher power state or vice versa, from a higher power state to a low power state.

Power states may include one or more of the following, which for some embodiments may represent a sequence of states going from lower to higher power: off, sleep, idle, lower frequency checking, higher frequency checking, low power on, or higher power on. In an off state, the system may be turned off with no power being drawn from power sources. In a sleep state, most power systems may be turned off, but power may continue to be supplied to the processor to allow it to turn other systems back on when needed. In an idle state, one or more sensors 104 may be turned on while the reader 101 is off or at a low power state. In a lower frequency checking state, the reader 101 may be turned on periodically such as once a day, every six hours, every three hours, every hour, every 15 minutes, every 10 minutes, every 5 minutes, every minute, or at a lower or higher frequency. The duration of being powered for the reader 101 may be for 10 minutes, 5 minutes, 1 minute, 30 seconds, 20 seconds, 10 seconds, 5 seconds, 1 second, 500 milliseconds, 250 milliseconds, 100 milliseconds, 10 milliseconds, 1 millisecond, or lower or higher durations. The higher frequency checking state may have one or both of a higher frequency or a longer duration than the lower frequency state. In some embodiments, there may be multiple levels of one or both of lower frequency checking states and higher frequency checking states. During a low power on state, the reader 101 may have a lower power read setting that may be able to detect non-blocked RFID chips between the reader 101 and the opposite boundary of a storage container, such as a floor. In a higher power on state, the reader 101 may be set at a power level that permits greater range and reflections from surfaces within a storage container or transport unit that will more reliably detect RFID tags that are hidden or partially or completely blocked from the reader 101.

In some embodiments, the higher power setting will use more power than other settings. In some embodiments, the higher power setting may be triggered to turn on after detection of an RFID tag that is unexpected, such as during a storage time period, during shipment, and/or during non-business hours. Detection of an RFID tag during an unexpected time period may be an indication of movement of packages that is not desired, damage to boxes holding RFID tagged items, theft of an RFID tagged item, unauthorized movement of packages, or other issues. Moving to a higher power setting may allow detection of all items being stolen, whether their tags are partially blocked or not, a full or more full inventory of the items within the container, trailer, transport unit, or other storage location.

In some embodiments, the reader 101 is communicatively connected to the one or more sensors 104 comprising a trigger sensor, such as one or more motion sensors 104b and/or any other sensors of interest. In some embodiments, the trigger sensor, such as a motion sensor 104b is configured to trigger the RFID reader 101 to come out of an idle state after either detecting something such as motion and/or after a predetermined amount of time has lapsed. For example, even though the RFID reader 101 may be communicatively connected to the door sensor 104a via the relay unit 110, the reader 101 may be configured to go into an idle state if the door sensor 104a is inactive for long durations when the doors of the transport unit are left open and/or after the number of RFID tag detections has fallen below a threshold. For example, the predetermined amount of time may be 1 minute, 2 minutes, 3 minutes, 5 minutes, 10 minutes, 20 minutes, 1 hour, 2 hours, or longer or shorter durations. The trigger sensor, such as the motion sensor 104b, may be configured to activate the RFID reader 101 from such an idle state if the trigger sensor detects activity and/or after a long duration of inactivity. In some embodiments, a timer circuit (not shown) may be operatively connected between the RFID reader 101 and the motion sensor 104a in order to activate the RFID reader 101.

In some embodiments, the cellular communication module 105 communicates to the processor 102 a real time location. For example, the cellular communication module 105 may be used to communicate to the processor 102 various operating parameters that can reconfigure operation of the system. For example, the processor 102 may be configured via the cellular communication module 105 to have one or more real-time locations of the places where the doors of the transport, storage, and/or shipping unit may be opened and/or times and/or dates when the doors may be opened. The cellular communication module 105 communicatively connected to the processor 102 is independent of any other cellular service that may be present on-board the vehicle.

In some embodiments, the integrated reader system 100 comprises a camera 106. In some embodiments, the camera 106 is configured to capture real time images and/or transmit the real time images to the processor 102 and/or to a server under certain conditions. The processor 102 may trigger an alert and/or record an image and/or video when an event, such as a prohibited, scheduled, predetermined, allowed, or unexpected event is detected through one or more components of the system. In some embodiments, the trigger for an event may include when movement of a door is detected. In some embodiments, the trigger for an event may be when a door of the vehicle is left open for a predetermined amount of time. In some embodiments, an event may include when one of the sensors 104 or the reader 101 detects a change in conditions in or around a transport unit 201, such as with respect to detection of movement, reduced light to a light sensor, acceleration above a threshold limit, changes in temperature above or below a threshold, detection of an RFID tag, failure to detect an RFID tag, detection of liquid that might be part of a leak, and other possible incidents.

FIG. 2A is a rear view of a vehicle 200 having a transport unit 201. In some embodiments, the vehicle 200 is a tractor having a trailer with doors 202. In some embodiments, the transport unit 201 may include a detachable trailer with doors. In other embodiments, the transport unit 201 may include an attached trailer or a combination of an attached and a detachable trailer. In some embodiments, the transport unit 201 may be used as a carriage unit for the transportation or storage of goods including loaded or unloaded goods such as cans, metal sheets, vessels, vehicles, aircrafts, cartons or any other goods or equipment. In some embodiments, the transport unit 201 may be transported by truck, train, container vessel, or by plane. In some embodiments, the transport unit 201 may be

In some embodiments and as may be seen in FIG. 2B, the integrated reader system 100 comprises one or more antennas 109 operatively connected to the energy storage device 103 (shown in FIG. 1), and communicatively connected to the RFID reader 101. In some embodiments, the one or more antennas 109 may be disposed on one or more side walls 204 of the transport unit 201. In other embodiments, at least one of the one or more antennas 109 may be disposed along a center line of the transport unit 202, along a roof, ceiling, or floor of the transport unit 201. Presence of multiple antennas may enable better reading of the contents of the transport unit 201.

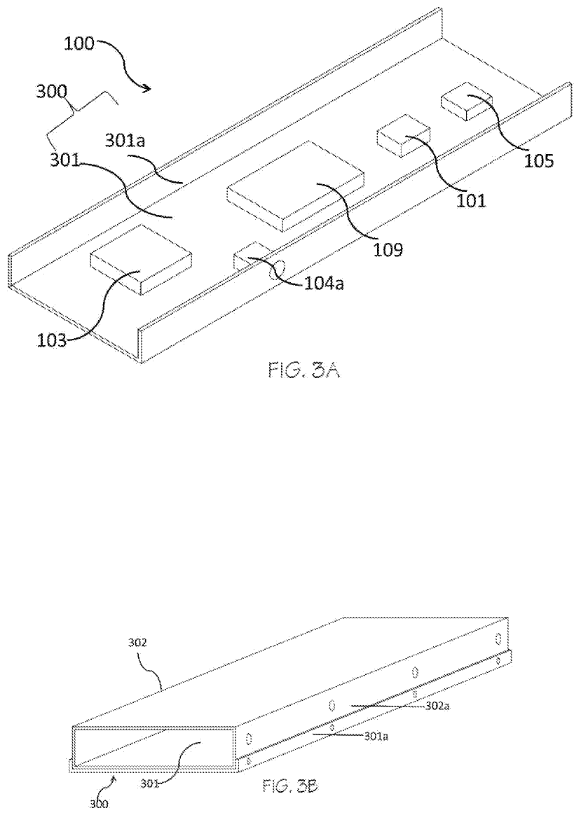

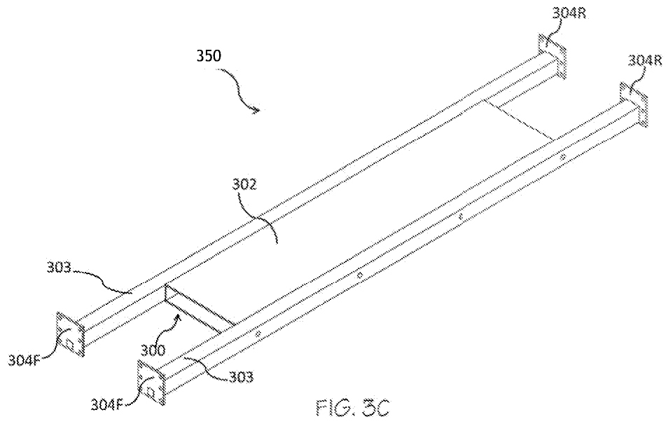

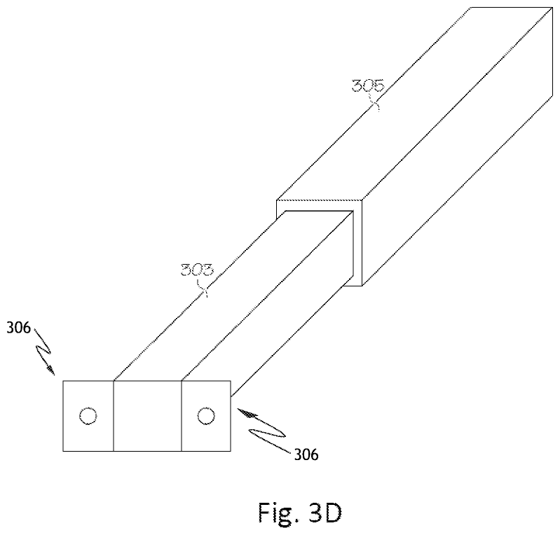

FIG. 3A illustrates a perspective view of a mounting tray 300 adapted to secure the integrated reader system 100. In some embodiments, various components of the reader system 100 are disposed along a length of an inner surface 301 of the mounting tray 300. The mounting tray 300 may be made of a material selected from a metal, an alloy or a polymer. In some embodiments, the mounting tray 300 receives/accommodates the energy storage device 103, the one or more antennas 109, the RFID reader 101 and the communication module 105.

As shown in FIG. 3B, the mounting tray 300 is adapted to be covered by a lid 302. In some embodiments, lid flanges 302a are fastened to tray flanges 301a (shown in FIG. 3A). In some embodiments, the lid flanges 302a are permanently secured to the tray flanges 301a.

In some embodiments and as shown in FIG. 3C, the mounting tray 300 along with the lid 302 is secured to at least one or a pair of extendable struts 303. In some embodiments, the extendable strut is a telescoping tubes, a collapsible bar, or a fixed beam that may be shifted in position relative to the support structure 305. For example, in some embodiments as shown in FIG. 3C, the pair of extendable struts 303 may be provided as independent elongated tubes spanning the length of the transport unit. However, in some embodiments and as illustrated in FIG. 3D, one end of the pair of extendable struts 303 may be inserted into at least one fixed support structure 305 provided in the transport unit. The geometry and construction of the fixed support structure 305 can vary based on the shape and dimensions of the transport unit. In some embodiments, one or more of the extendable struts 303 is sleeved over the corresponding support structure 305 or vice versa, the support structure 305 is sleeved over the corresponding extendable strut 303. In some embodiments, two oppositely directed extendable struts 303 may be sleeved over by the same support structure 305 formed as a hollow tube. In some embodiments, two oppositely directed extendable struts 303 may be sleeved one over the other such that each of the extendable struts 303 may have the same or a slightly shorter length than the support structure 305 that it is stored within, allowing the extendable struts 303 to extend farther while still being sleeved within a single hollow interior of a support structure 305 formed as a tube. In some embodiments, each extendable strut 303 has its own support structure 305, and two or more support structures 305 may be mounted at each of two opposite sides of the mounting tray 300.

In some embodiments, the mounting tray 300 along with the lid 302 is bolted or otherwise secured to sides of each telescoping tube to form an assembly. Each telescoping tube of the pair of extendable struts 303 comprises a front mounting flange 304F and a rear mounting flange 304R. In some embodiments, the front mounting flange 304F and the rear mounting flange 304R are firstly secured to opposite walls of the transport unit, followed by securing the mounting tray 300 to the pair of extendable struts 303. In some embodiments, the opposite walls of the transport unit include the side walls of the transport unit.

In some embodiments, the system includes mounting flanges 306 disposed at opposite sides of an end of a support strut 303. In some embodiments, the mounting flanges are rotatable to allow securing to a wall or ceiling.

In some embodiments, the mounting tray assembly 350 is secured to the walls of the transport unit in a manner such that the reader system 100 is disposed just below a ceiling of the transport unit. In some embodiments, the mounting tray assembly 350 is secured to the walls of the transport unit in a manner such that the integrated reader system 100 is disposed along a length of the transport unit 201. In some embodiments, the mounting tray assembly 350 is secured to the walls of the transport unit 201 in a manner such that the integrated reader system 100 is disposed along a width of the transport unit. In some embodiments, the mounting tray assembly 350 is secured to the walls of the transport unit in a manner such that the integrated reader system 100 substantially overlaps a storage area of the transport unit.

The construction of the telescoping tubes is not limited to the description.

### Exemplary Computer System

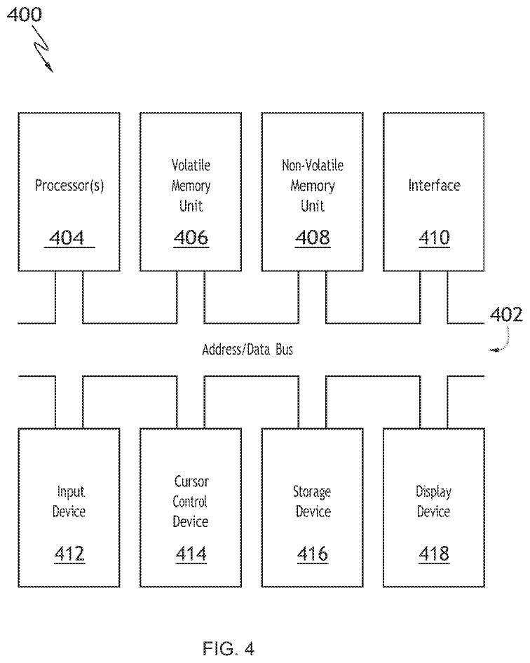

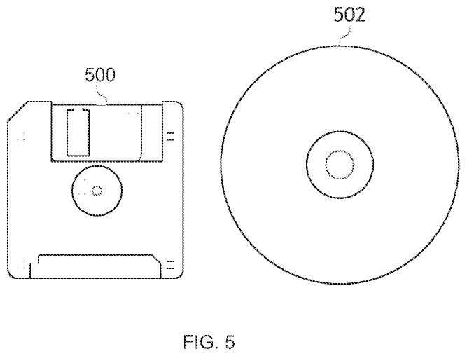

A block diagram depicting an example of a system (i.e., computer system 400) that may be used to process signals and/or perform operations described in this disclosure is provided in FIG. 4. The computer system 400 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 400. When executed, the instructions cause the computer system 400 to perform specific actions and exhibit specific behavior, such as described herein.

The computer system 400 may include an address/data bus 402 that is configured to communicate information. Additionally, one or more data processing units, such as a processor 404 (or processors), are coupled with the address/data bus 402. The processor 404 is configured to process information and instructions. In an aspect, the processor 404 is a microprocessor. Alternatively, the processor 404 may be a different type of processor such as a parallel processor, application-specific integrated circuit (ASIC), programmable logic array (PLA), complex programmable logic device (CPLD), or a field programmable gate array (FPGA).

The computer system 400 is configured to utilize one or more data storage units. The computer system 400 may include a volatile memory unit 406 (e.g., random access memory (“RAM”), static RAM, dynamic RAM, etc.) coupled with the address/data bus 402, wherein a volatile memory unit 406 is configured to store information and instructions for the processor 404. The computer system 400 further may include a non-volatile memory unit 408 (e.g., read-only memory (“ROM”), programmable ROM (“PROM”), erasable programmable ROM (“EPROM”), electrically erasable programmable ROM “EEPROM”), flash memory, etc.) coupled with the address/data bus 402, wherein the non-volatile memory unit 408 is configured to store static information and instructions for the processor 404. Alternatively, the computer system 400 may execute instructions retrieved from an online data storage unit such as in “Cloud” computing. In an aspect, the computer system 400 also may include one or more interfaces, such as an interface 410, coupled with the address/data bus 402. The one or more interfaces are configured to enable the computer system 400 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 400 may include an input device 412 coupled with the address/data bus 402, wherein the input device 412 is configured to communicate information and command selections to the processor 100. In accordance with one aspect, the input device 412 is an alphanumeric input device, such as a keyboard, that may include alphanumeric and/or function keys. Alternatively, the input device 412 may be an input device other than an alphanumeric input device. In an aspect, the computer system 400 may include a cursor control device 414 coupled with the address/data bus 402, wherein the cursor control device 414 is configured to communicate user input information and/or command selections to the processor 100. In an aspect, the cursor control device 414 is implemented using a device such as a mouse, a track-ball, a track-pad, an optical tracking device, or a touch screen. The foregoing notwithstanding, in an aspect, the cursor control device 414 is directed and/or activated via input from the input device 412, such as in response to the use of special keys and key sequence commands associated with the input device 412. In an alternative aspect, the cursor control device 414 is configured to be directed or guided by voice commands.

In an aspect, the computer system 400 further may include one or more optional computer usable data storage devices, such as a storage device 416, coupled with the address/data bus 402. The storage device 416 is configured to store information and/or computer executable instructions. In one aspect, the storage device 416 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 418 is coupled with the address/data bus 402, wherein the display device 418 is configured to display video and/or graphics. In an aspect, the display device 418 may include a cathode ray tube (“CRT”), liquid crystal display (“LCD”), field emission display (“FED”), Light Emitting Diode (“LED)”, plasma display, or any other display device suitable for displaying video and/or graphic images and alphanumeric characters recognizable to a user.

The computer system 400 presented herein is an example computing environment in accordance with an aspect. However, the non-limiting example of the computer system 400 is not strictly limited to being a computer system. For example, an aspect provides that the computer system 400 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

An illustrative diagram of a computer program product (i.e., storage device) is depicted in FIG. 5. The computer program product is depicted as floppy disk 500 or an optical disk 502 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

What has been described above includes examples of the claimed subject matter. It may be, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter may be intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An integrated reader system for reading radio frequency identification (RFID) tags in a transport unit of a vehicle, the integrated reader system comprising:
an RFID reader;
a processor functionally connected to the RFID reader; and
an energy storage device operatively connected to the RFID reader and configured to independently power the RFID reader.

2. The integrated reader system of claim 1, wherein the system comprises one or more sensors communicatively connected to the RFID reader, the one or more sensors comprising a door sensor.

3. The integrated reader system of claim 1, wherein upon detection of movement of a door of the transport unit by the door sensor, the processor is configured to cause the RFID reader to move from a first state to a second state.

4. The integrated reader system of claim 3, wherein the first state is a lower power state, and the second state is a higher power state.

5. The integrated reader system of claim 2, wherein the door sensor is communicatively connected to the reader via a relay circuit.

6. The integrated reader system of claim 1, wherein the energy storage device is operatively connected to the reader via a relay circuit.

7. The integrated reader system of claim 6, wherein the relay circuit comprises a relay unit, a fuse, and a switch.

8. The integrated reader system of claim 1, wherein the energy storage device is connected to a charging circuit.

9. The integrated reader system of claim 8, wherein the charging circuit comprises a solar cell.

10. The integrated reader system of claim 8, wherein the charging circuit comprises a motor generator.

11. The integrated reader system of claim 8, wherein the charging circuit is connected to a wiring harness of the vehicle.

12. The integrated reader system of claim 1, wherein the energy storage device is connected to a remote battery unit.

13. The integrated reader system of claim 1, wherein the energy storage device is connected to a power unit.

14. The integrated reader system of claim 1, wherein the one or more sensors further comprises a motion sensor communicatively connected to the RFID reader, wherein the motion sensor is configured to trigger the reader to come out of an idle state after the motion sensor detects movement.

15. The integrated reader system of claim 1, wherein the reader is a micro reader.

16. The integrated reader system of claim 1, further comprising a cellular communication module operatively connected to the reader and the processor.

17. The integrated reader system of claim 16, wherein the cellular communication module is configured to communicate a real-time location of the vehicle to the processor.

18. The integrated reader system of claim 1, wherein the processor is configured to trigger an alert on detection of a prohibited event.

19. The integrated system of claim 18, wherein the prohibited event includes movement of the door.

20. The integrated reader system of claim 1, wherein the system further comprises a camera.

21. The integrated reader system of claim 19, wherein the camera is operatively connected to the cellular communication module.

22. The integrated reader system of claim 1, further comprising one or more antenna communicatively coupled to the reader, and wherein the one or more antenna are disposed on side walls of the transport unit.

23. The integrated reader system of claim 1, wherein the reader system is secured in a mounting tray.

24. The integrated reader system of claim 23, wherein the reader system is secured along an inner surface of the mounting tray.

25. The integrated reader system of claim 24, wherein the mounting tray is covered by a lid.

26. The integrated reader system of claim 23, wherein the mounting tray along with the lid are secured to a pair of telescoping tubes to form a mounting tray sub-assembly.

27. The integrated reader system of claim 26, wherein each telescoping tube of the pair of telescoping tubes comprises a front mounting flange and a rear mounting flange.

28. The integrated reader system of claim 27, wherein the front mounting flange and the rear mounting flange enable in securing the mounting tray assembly to opposite walls of a transport unit.

29. The integrated reader system of claim 28, wherein the opposite walls include side walls of the transport unit.

30. The integrated reader system of claim 26, wherein said each telescoping tube of the pair of telescoping tubes is inserted into at least one fixed structure provided in the transport unit.

31. The integrated reader system of claim 24, wherein the mounting tray is disposed just below a ceiling of the transport unit.

32. The integrated reader system of claim 1, wherein the transport unit is permanently attached to the vehicle.

33. The integrated reader system of claim 1, wherein the transport unit is detachably attached to the vehicle.

34. A method comprising;
using an integrated reader system for reading radio frequency identification (RFID) tags in a transport unit of a vehicle, the integrated reader system comprising an RFID reader, a processor functionally connected to the RFID reader, one or more sensors communicatively connected to the RFID reader, the one or more sensors comprising a door sensor, and an energy storage device operatively connected to the RFID reader and configured to independently power the RFID reader, upon detection of movement of a door of the transport unit by the door sensor, causing the RFID reader to move from a first state to a second state.

35. The method of claim 34, wherein the first state is a lower power state, and the second state is a higher power state.
